(19) United States
(12) Patent Application Publication
(10) Pub. No.: US 2013/0297476 A1
(43) Pub. Date: Nov. 7, 2013

(54) Systems and Methods of Derivative Strategy Selection and Composition

(71) Applicant: NUTECH VENTURES, INC., Lincoln, NE (US)

(72) Inventor: Greg Hammond, Lincoln, NE (US)

(73) Assignee: NUTECH VENTURES, INC., Lincoln, NE (US)

(21) Appl. No.: 13/731,695

(22) Filed: Dec. 31, 2012

Related U.S. Application Data
(60) Provisional application No. 61/642,306, filed on May 3, 2012.

(51) Int. Cl. G06Q 40/04

(52) U.S. Cl. CPC G06Q 40/04
USPC 705/37

(57) ABSTRACT

A method and apparatus of selecting derivative strategies, where candidate derivative strategies are selected from a set of essentially all possible derivative strategies available for an underlying, based upon a user's market sentiment for an underlying, to perform favorably under the foreseen conditions being most appropriate to the user's strategic intent and the choices afforded by the relevant markets.

### CROSS REFERENCE TO RELATED APPLICATIONS

This application claims priority from U.S. Provisional Application 61/642,306, filed May 3, 2012 and entitled “Best Option Trading” which is hereby incorporated herein by reference in its entirety.

### FIELD OF THE INVENTION

The present invention relates generally to an apparatus and method for the determination of appropriate derivative strategies and the composition thereof. The invention is concerned with the actions taken by an “actor”, meaning a person or system that initiates the process to use the outputs to place a trade in market(s), for edification, as inputs into another system, or for any other use, beginning at the point in which a market forecast has been determined for an underlying. Once the apparatus and method presents the actor with specific strategies with specific compositions appropriate to their market forecast, the process is concluded. Processes immediately following those of the apparatus and method could include placing an order or orders in market(s), editing order(s), saving order(s) for later, concluding an edification process, evaluating outputs(s), analyzing output(s), beginning the processes of the apparatus and method again, or taking another action linked to the processes of the apparatus and method.

### BACKGROUND OF THE INVENTION

Derivative strategies exist in relation to an underlying. An underlying may itself be a derivative strategy, but is commonly common stock in a corporation, an exchange-traded-fund, a commodity contract, an indicator, index, foreign-currency exchange rate, interest-rate, or something similar. Derivative types are traded separately in market(s) specific to the product upon which they are based. Derivative types often share certain commonalities, an example of which is the tendency for them to have an expiration date, a strike price, a deliverable, the right to exercise the contract, and so forth. Most derivative types have more than one way in which they may be traded, whether through selection of specific instruments, timing, combination, or another complicating consideration, which may be referred to as derivative strategies. Financial options, specifically complex financial options on equity products, are a widely traded and well understood derivative type that has a very large number of possible strategies. An exemplary strategy—a strangle-straddle-swap—will be used throughout to explain the processes and implications of the apparatus and method, although other similar processes may be applied to other strategies of the derivative type and strategies of other derivative types. The complex option strategy is comprised of four simple option contracts: a short call option and a short put option at an expiration date and a long call option and long put option at an expiration date further into the future than the first. To compose a specific derivative strategy, the actor must, when trading financial options on tradable underlying(s), select one or more of the following: call option(s), put option(s) and the underlying itself. Each can exist as a standalone, or be assembled to form a complex derivative strategy. The strategy may be represented as a combination of other strategies, and may be known by several different monikers (including some likely to be coined in the future), but any name still refers to the same collection and organization of basic symbols (defined herein) to form the derivative strategy.

Electronic trading systems generally accept bids and offers in the form of “orders.” These orders consist of data entered by actors. With advances in internet technology allowing the emergence of self-directed brokerage accounts, an ever-increasing number of people elect to interact in the market as participants without a person acting as an intermediary, and many of those people choose to trade derivatives contracts. With so many people trading derivatives that are not financial trading professionals, there is a wide gap between the level of sophistication required to participate in the market effectively and the skills of most actors, which is why the technology seeks to close that gap by elevating the effectiveness of the less sophisticated actors.

Currently, when determining a derivative strategy, the actor is required to make a series of difficult decisions. The current state of the art thus contains what will be referred to as a “decision problem.” The decision problem is the difficulty of selecting an optimal strategy for an underlying where the underlying is comprised, of one or many derivatives, each derivative with multiple attributes—some static and some dynamic—that taken together, give rise to an optimal strategy. The decision problem begins when an actor has determined their forecast for the underlying (or the user's market sentiment) and wants to determine an appropriate derivative strategy in a specific composition. The decision problem involves choices by the actor, wherein he or she must determine which derivative strategy or strategies are best suited to establish a market position given their sentiment for the underlying on which the derivative instruments are based. Inherent in this process, several factors and combinations must be considered to ensure good results each time. With any given complex derivative strategy, having more than one constituent derivative instrument, the combination of instruments requires evaluation of the individual instruments, and also the set and/or sub-sets that the instruments make. Each unique derivative instrument has attributes specific to it that do not change, such as a contract expiration date or contract strike price; attributes that do change at the pace of the market, such as contract volume traded that day or ask price for a contract. The attributes that change with the market often do so continuously, at a sub-second pace, sometimes dramatically, making evaluation and selection often hurried and necessarily reliant upon stale information when a human tackles the decision problem manually. The total number of generic derivative strategies is often very numerous and there are tweaks and variants of most derivative strategies, where there is more than one specific strategic use of the generic strategy or method sharing a commonly recognized name, but where the constitute instruments' attributes' values fall within acceptable ranges and the combinations meet expectations for that variant. For each specific derivative strategy, there is an associated expected market cost, whether in cash or margin funds, expected transactions costs, and other considerations specific to a trading/investment account, many of which are variable and dependent upon the quantity of the specific instruments and/or quantity of strategies. The size of the market position that the derivative strategy can establish is restricted by the amount of funds that the actor would like to use. The ability for the market to transact the quantities required to establish a market position of a certain size also needs to be taken into account to avoid excessive slippage, which increases transactions costs through a varied and worsening transaction price, and to better the chances of a full, rather than partial, execution of the strategy, so that the intended market position is accomplished. Since there are so many factors to consider, and they should all be ideally considered instantaneously, a human who tackles the decision problem necessarily does so reliant upon heuristic methods, contributing toward less than optimal outcomes over repeated “decision problems.” Innocent errors also result due to the analytical skill, domain specific knowledge, and mental load required to manually process the information.

Currently, there are several commercial software offerings such as, strategySEEK™ by tradeMONSTER, TradeBuilder by TradingBlock, and Strategy Optimizer by E*TRADE that attempt to assist an actor in composing financial options strategies. These tools address the decision problem of strategy determination and composition that is tackled by an actor in the financial options markets each time that they want to place an order in the markets. These current tools generate derivative strategies that are composed to suit the intent of the actor, but fall short because they fail to be comprehensive in their approach. The decision problem which results in innocent errors and less than optimal decision making because of some combination of the inability of humans to read and evaluate large amounts of data in fast moving markets, a lack of experience, demanding calculations, a very large number of choices, and the fact that each strategy and each symbol has descriptive attributes which have a differing values. One example of a failure to take a comprehensive approach is that much of this software excludes commissions, which favors the brokerage houses and leads to uninformed and inefficient trading decisions by the actor. A second example of a common shortcoming is the presentation of derivative strategies to the actor that are not suitable to the indicated forecast for the underlying. Thirdly, but not exhaustively, it is sometimes the case that one or more adequate derivative strategies will be provided among a large number of outputs without any differentiation, because of a failure to determine appropriate strategies comprehensively. If an actor manages to understand that the combinations are finite and theoretically comprehensible, that fact does not make the decision problem itself easier for the actor. The processes of the apparatus and method remove the burden from the actor, allowing them to use derivative strategies without a lot of derivative strategy specific knowledge and without making often poor decisions or innocent errors related to the selection of derivative strategies or the composition thereof.

### SUMMARY OF THE INVENTION

Discussed herein are various embodiments of the present invention.

It is a purpose of the present invention to provide a method and apparatus for the selection and composition of derivative strategies for options and other derivatives on underlyings.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

The features and advantages of the invention are explained in more detail in the subsequent detailed description with reference to the embodiments illustrated in the attached drawing figures, in which like reference numerals denote like elements and in which FIGS. 1-5 illustrate some embodiments of the present invention.

FIG. 1A is a flow chart schematic of one embodiment of the present invention.

FIG. 1B is a flow chart showing particular attributes of on embodiment of the present invention.

FIG. 2 is an example formula for use in a specific embodiment of the present invention.

FIG. 3 is a chart showing Node number and location according to a specific embodiment of the present invention.

FIG. 4A is a diagram of specific Nodes according to a specific embodiment of the present invention.

FIG. 4B is a diagram of specific Nodes according to a specific embodiment of the present invention.

FIG. 4C is a further view of the specific embodiments of FIGS. 4A-4B.

FIG. 4D is a diagram of specific Nodes according to a specific embodiment of the present invention.

FIG. 4E is a diagram of specific Nodes according to a specific embodiment of the present invention.

FIG. 5 is an example Risk/Reward profile according to a specific embodiment of the present invention.

### DETAILED DESCRIPTION OF THE INVENTION

The various methods and apparatus disclosed herein relate to devices for use in the determination of derivative strategies and the composition thereof. More specifically, various embodiments relate to various methods and apparatus relating to the determination of derivative strategies and the composition thereof.

It is understood that the various embodiments of these apparatus and related methods and systems disclosed herein can be incorporated into or used with any other known apparatus, systems, and methods. Although the present invention has been described with reference to preferred embodiments, persons skilled in the art will recognize that changes may be made in form and detail without departing from the spirit and scope of the invention.

The current software tools described above are flawed because they fail to take a comprehensive approach to the determination of appropriate derivative strategies and the composition thereof. Further, the current products make use of processes that are not sufficiently comprehensive to generate results that are consistently suitable to actors' forecast. Often derivative strategies and the composition thereof is wholly inappropriate for the Actor's expressed market sentiment for the underlying, where, for instance, a derivative strategy may benefit from an increase in the price of the underlying and the market sentiment specifies a decrease in the price of the underlying, or another critical factor is not properly taken into account. Another common shortcoming is that a software tool will produce a plethora of results, without any indicator of which is best; a failure to make that distinction means that the software does little more than list the most obvious combinations and compositions, providing little benefit for the actor. This is, fundamentally, because proper outputs cannot be generated reliably without taking into account the full comprehensive scope of decision criteria that should contribute to the selection of acceptable strategies and the best composition of each of those strategies. Therefore, because of the scope of market data, the variety of choices in the attributes of financial options and the often hurried pace of the process, a large number of actors make innocent errors or unfortunate choices when determining derivative strategies and the composition thereof.

Unlike the prior art approaches to the determination of derivative strategies and the composition thereof, which address the decision problem without providing a comprehensive solution, the present invention recognizes that there are a limited number of basic building blocks and rules that govern the method: call options, put options, equity, long and short, and the like. The sum total of all of these building blocks, constraints, mathematical relationships, market rules, with others, can be evaluated in the entirety to provide the actor with greater accuracy and outcomes when engaging in options trading. As such, the present invention approaches options and/or derivatives trading differently by addressing the decision problem as a finite set of discrete variables, including the various balance(s) in the actor's account(s), other positions, the expressed preferences of the user, the brokerage(s) commission scheme(s), the volatility forecast, the forecast for the underlying, and so forth. The constituent symbols with accompanying attributes, all of which is available by network or other means, including static values, dynamic values, and required attributes. When the actor is using the method and apparatus for financial options trading on equity underlying(s), they may choose from among several derivative strategies, such as “long call calendar spread,” “short cash-secured put,” or “short iron butterfly,” among many other, whether widely recognized or not.

An option contract is a financial derivative contract that conveys to its holder the right to exercise the option to take ownership of an underlying security or settle with another method. These underlying securities are stock in a company, an exchange-traded fund, an underlying good, service, security, commodity, market index, and so forth. Options may be exercised on or before the “expiration date,” depending on the style, if the contract is not perpetual. Electronic trading systems allow a user to enter a bid or offer on a particular tradable item, known as a “derivative contract,” where contracts are created (derived) in relation to underlying(s). As further described herein, when long call option(s), short call option(s), long put option(s), short put option(s), long underlying(s), short underlying(s) are grouped as two or more, the grouping often, but not always, forms a combined or “complex” position. These “complex” positions have strategy risk/reward profiles and strategy analytics with characteristics that differ from the individual or “simple” positions that comprise them.

Herein certain terms are defined within the field of practice described, and these terms should be readily understood. “Option contract” means a contract that conveys to its holder the right, but not the obligation, to buy or sell quantities of an underlying good, service, security, commodity, market index, or other exchangeable item at a specified price on or before a given date, depending upon the style of options trading and specified settlement method, as described more fully below. A “call option” is a type of option contract granting the purchaser the right, but not the obligation, to buy a certain number of units of the underlying at the strike price of the contract or settle by another specified method. A “put option” is a type of option contract granting the purchaser the right, but not the obligation, to sell a certain number of units of the underlying at the strike price of the contract or settle by another specified method. When an actor purchases a call option or sells a put option it establishes an indirect “long position” on the underlying, whereas the option contract(s) is itself long or short, respectively; buying a put option or selling a call option establishes an indirect “short position” on the underlying. A long call option, short put option or long underlying is a “bullish” position on the underlying, whereas a short call option, long put option or short underlying is “bearish”.

“Underlying” means a security or metric that can serve as a basis on which a derivative contract can trade. An underlying for an option contract is often common stock, an exchange-traded-fund, or an index, but can also be a futures contract or any number of other things. These are also commonly referred to as an “underlying good”, “underlying instrument”, or by many other names well known in the art. Derivatives based upon underlyings can pertain to property, freight, inflation, interest-rate(s) and basis, weather, exchange rates, equity, credit, volatility and variance, asset(s), games (e.g. sports scores or statistics, gambling, and so forth), notes, bonds, duration, natural resource deposits, commodities, real options, account balance(s), credit default or any event, be it political, economic, or any defined and tradable state-of-the-world), or any underlying that is itself a derivative, exchange-traded and over-the-counter derivative contracts, speculative, hedging, options—standard, barrier, coupe, mountain, knock-in, and so forth—swaps, swaptions, warrants, range accruals, caps and floors, forward-rate agreements, and so forth, vanilla options—such as those of American or European style—and exotic options, such as those of Asian or Bermudan style. The present invention also addresses multiple combinations of underlyings, such as one underlying (e.g. call or put), two or more underlyings (e.g. a rainbow contract), paired underlyings (e.g. a pairs contract), a weighted basket of underlyings (e.g. basket contract), and so on. “Premium” means the price or value assigned to an option contract or other financial product by trading counter parties, through negotiation, purchase, sales or another mechanism, whether anonymously or not, or by way of a market maker or other means. “Market position” means an actor's stake in a market, for example in that owning any security establishes a position for an actor in one or more markets, such as the equity market for common stock shares of a specific company, a specific interest-rate market, or any other market(s). When establishing a long or short position, whether directly or indirectly, in a given security or underlying, the intent of the actor, such as to speculate, establish a hedge, or some combination of these motivations, does not affect the analytical properties of the position. Neither does it matter if it establishes a new position, closes out an existing position, or alters an existing position, except to the extent that tax considerations or another outcome is relevant. Further, it does not matter if the position is in a financial market, for the purposes of gambling, or for any other purpose, including trivial purposes. The requirement for establishing a market position is that an actor transacts with an instrument in an established market. “Strike price”, also known as the “exercise price” or “contract price,” is the price at which the purchaser and seller agree to transact for a certain number of units of the underlying in the event that the contract is exercised, where the seller settles in cash, delivers units of a security, or makes physical delivery to settle the contract and the purchaser makes payment per-unit at the contract strike price.

“Short selling”, where an actor sells an underlying when they don't first own it to establish a “bearish” position on the underlying, often requires that the actor have the ability to use margin in their account, but always requires that the symbol is shortable and that units to borrow may be located. Most option contracts have an “expiration date,” beyond which the purchaser of an option contract may no longer exercise to acquire units of the underlying and the seller may no longer be “assigned” requiring the acceptance of units of the underlying upon delivery by the purchaser. “Volatility” is a measure of how rapidly the price of a security, commodity, or other instrument is likely to change over a certain time period. “Implied volatility” of the underlying is a measure of the future expectation of the magnitude of price change in the underlying, either an increase of decrease in price, for a given period of time. “Leverage” describes the degree of market exposure that an actor has to an underlying as accomplished by taking a position in a derivative instrument on that underlying, thereby often committing less funds to the position in respect to the overall market exposure than would be the case if no derivatives contracts were used, which will increase the amount of gain or loss on the position for any given change in the price of the underlying, as compared to a similarly less leveraged position.

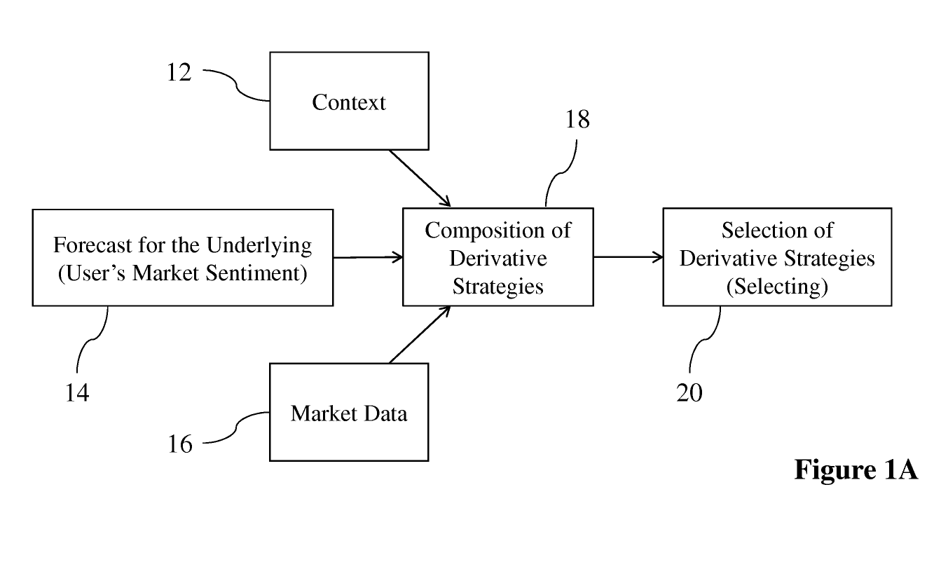

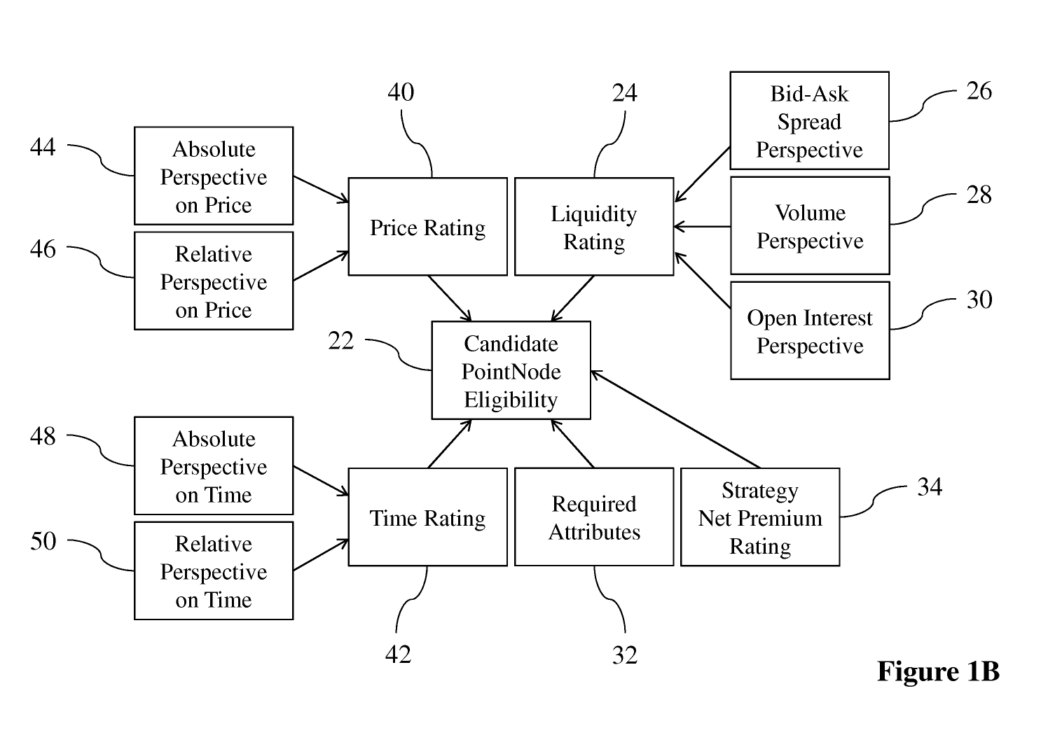

FIG. 1A shows a top level flow chart of one embodiment of the present invention 10. In this embodiment, context 12 contributes to the composition of derivative strategies 18 along with the forecast for the underlying (user's market sentiment) 14 and market data 16. The actor evaluates the symbols available through market data 16 to constitute these derivative strategies, considering the attributes of each symbol, the combined effect of symbols in forming a specific derivative strategy, and the specific derivative strategy's strategy risk/reward profile and strategy analytic(s) in relation to the actor's forecast for the underlying (user's market sentiment) 14, and all relevant factors related to the actor's context 12.

The factors that comprise context 12 may act as constraints, bias, influence or filter results directly or indirectly. They include factors that are brokerage specific, account specific, market specific, preferences, and behaviorally influenced, whether passively or actively, directly or indirectly, individually or jointly. An example of a brokerage specific factor is “margin or risk system(s)”, where the types or amounts of derivative securities that are allowable to be traded may be reliant upon the business rules of the brokerage. An example of an account specific factor is “option approval level”, where certain derivative strategies may not be tradable in an actor's account. An example of a market specific factor is the market opening and closing times that a broad-based exchange-traded-fund is permitted to trade on the NYSE Arca exchange. An example of a preference is the degree to which an actor likes or dislikes a particular derivative strategy, introducing bias. An example of behavioral influence is past trading activity. Any relevant factor that should be taken into account, but is not accessible through market data 16 or actors' forecast for the underlying (user's market sentiment) 14 is in context 12, inclusively.

Market data 16 as shown in FIG. 1A includes the identity of an underlying, bid and ask price at each point in time, bid and ask size at each price for each point in time, volume at each point in time, daily open interest, short interest at each point in time, dividend amounts, dividend timing, dividend expectations of certainty, and records of past dividends, interest rates, fundamental data about underlying(s), and so forth. In some embodiments, the market data 16, can include attributes of symbols such as strike price, expiration date, volume, trading times, and the like, and is included in the composition of derivative strategies 18. The present invention thus determines derivative strategies and their composition thereof based upon these inputs, selecting 20 from the available candidate strategies to provide the actor with the specific derivative strategies that are appropriate given the actor's forecast for the underlying 14. In certain embodiments of the present invention, sophisticated actors may enter their own parameters to govern the composition of novel or adapted derivative strategies. This process takes place independently of the automated determination of derivative strategies and their composition thereof.

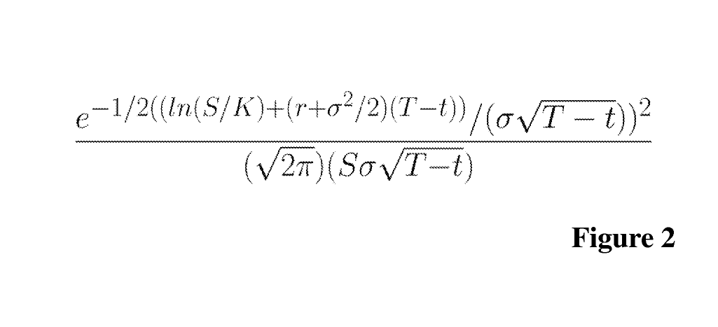

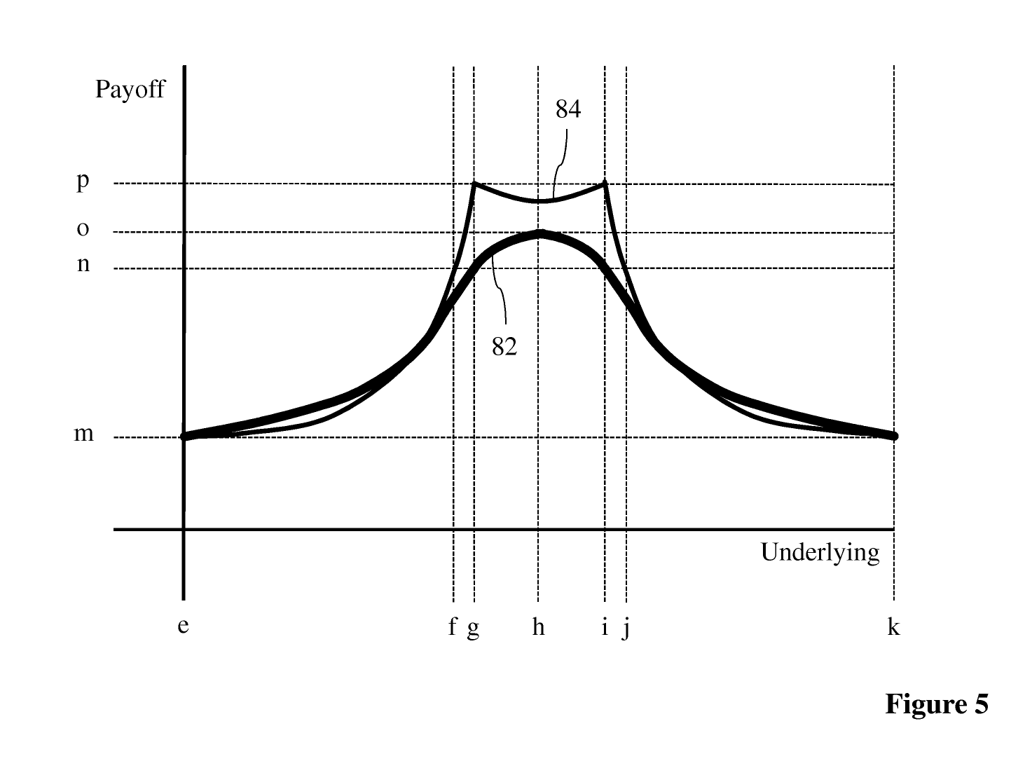

FIGS. 1A-B show one embodiment of the selection of derivative strategies 20, which takes specifically composed derivative strategies and selects the derivative strategies that are fully appropriate to the forecast for the underlying 14 to provide to the actor. The actor may select any of the strategies provided to them. Many actors will also consider strategy risk/reward profile (shown in FIG. 5) and various strategy analytics (an example of which is shown in FIG. 2) for each output of the selection of derivative strategies (selecting) 20 process, in order to select the specific derivative strategy and composition thereof that they feel best accomplishes their intent and has the risk and reward characteristics and analytical properties with which they are most comfortable. If the actor is correct in their forecast for the underlying (user's market sentiment) 14 they will be profitable and may be profitable despite some margin of error in the forecast. The derivative strategies provided to the actor are the most suitable derivative strategies and the best specific composition of each derivative strategy. FIG. 2 shows Black-Scholes Gamma as an example of a “strategy analytic” (although it is not specific to the example strategy used). FIG. 5 shows a payoff diagram for the exemplary strategy that shows the corresponding risk/reward profile. The risk/reward profile and the strategy analytic are used to explain how an actor makes a choice from the outputs that the described processes generate, where each output has a different risk/reward profile and differing values for “strategy analytics,” of which there are very many.

Thereby in certain embodiments, the present invention combines this information in an evaluative process which results in selection of derivative strategies (selecting) 20. The present invention thus accepts the actor's forecast for the underlying (user's market sentiment) 14, including the underlying stock symbol, the expected price change, the expected change in time, the expected implied volatility for the underlying, and the total amount to be committed, in dollars, percentage, or some other measure of capital, as is further shown in FIGS. 1A-B.

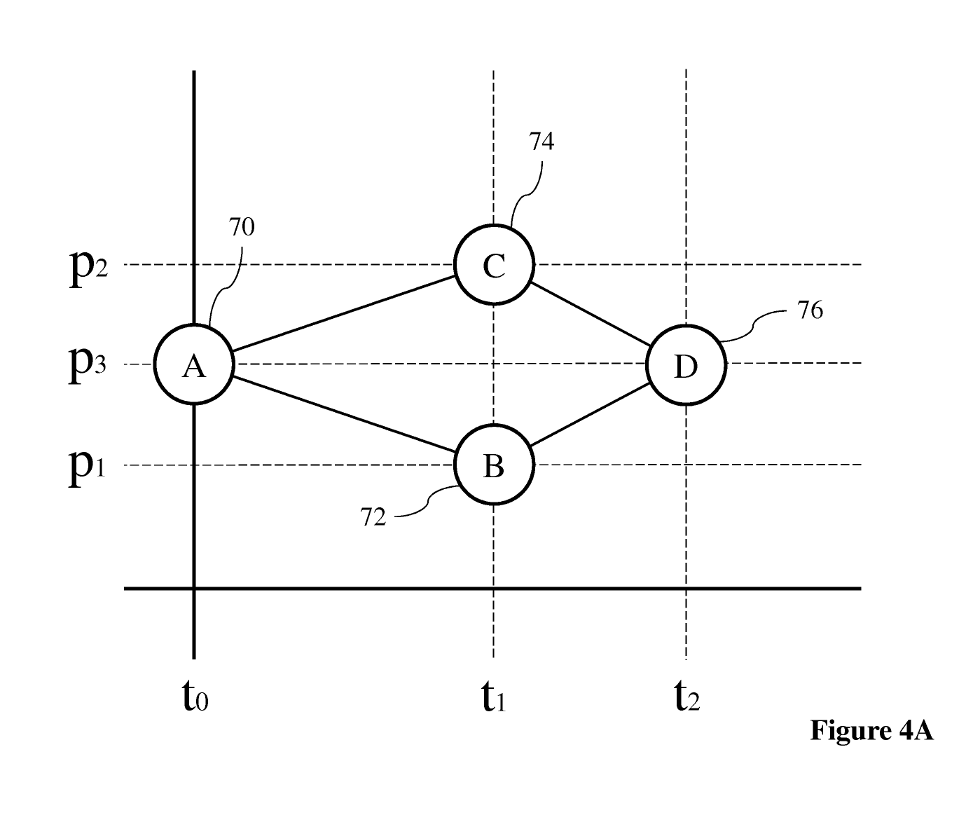

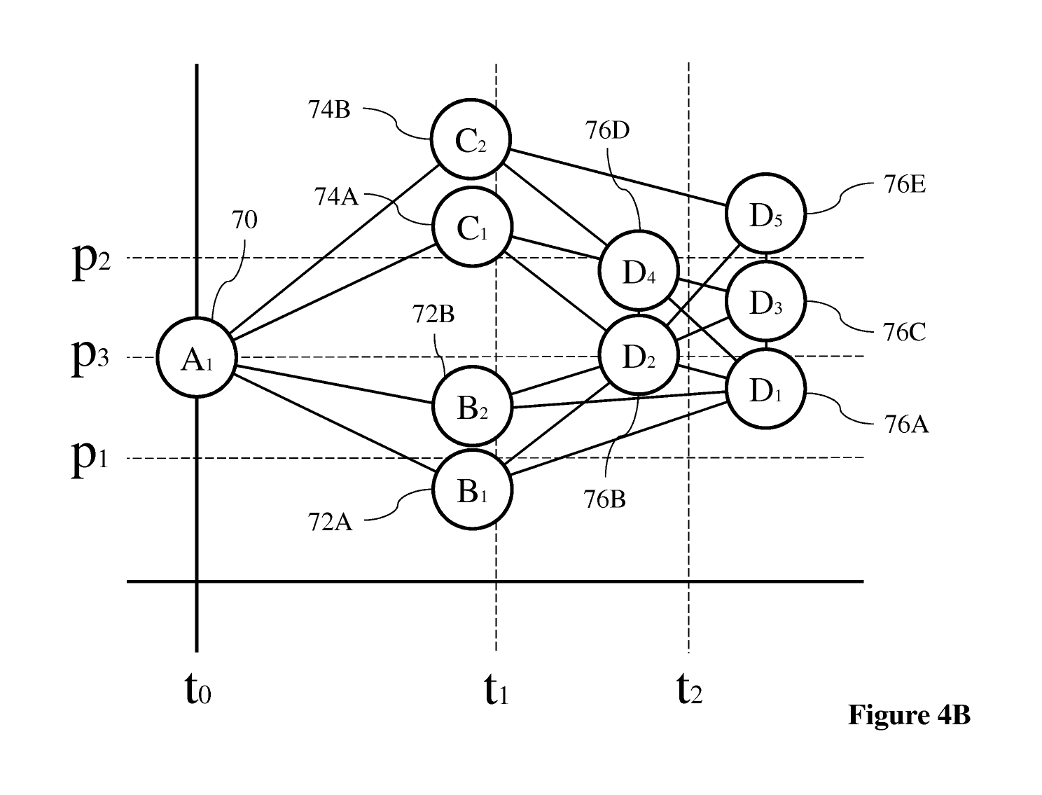

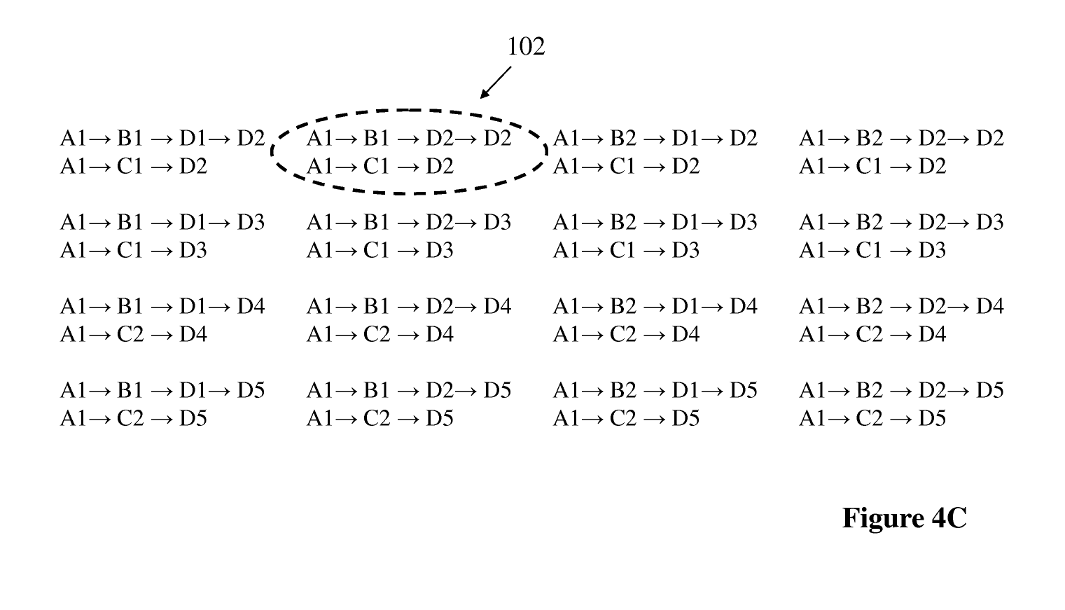

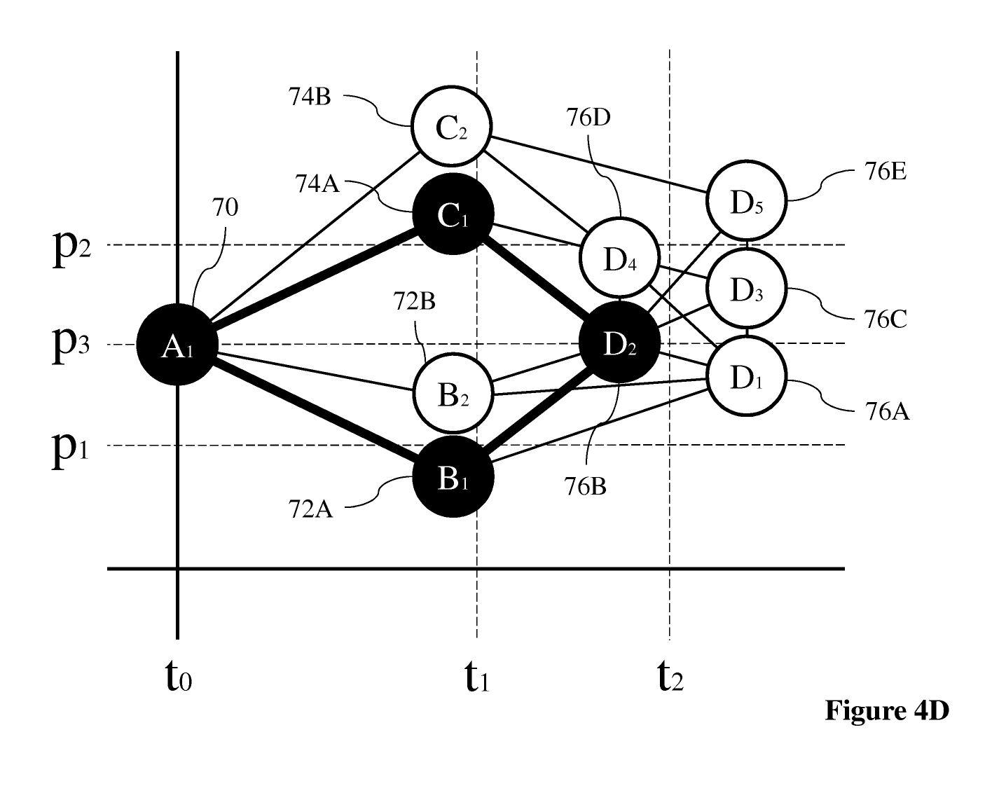

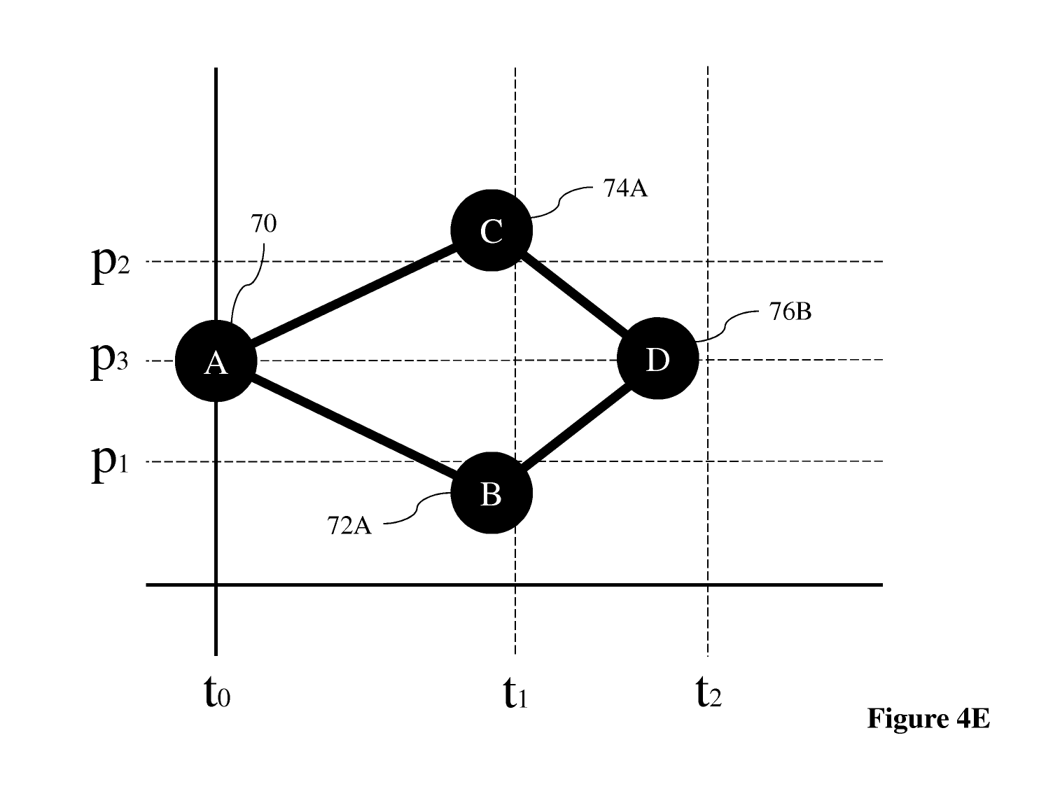

FIG. 1B shows how candidate PointNode eligibility 22 requires liquidity rating 24 that depends upon bid-ask spread perspective 26, volume perspective 28 and open interest perspective 30 as well as required attributes 32 which are either present or are not for a given symbol, price rating 40, which depends upon absolute perspective on price 44 and relative perspective on price 46 time rating 42 which depends upon absolute perspective on time 48 and relative perspective on time 50, and strategy net premium 34. Once candidate PointNode eligibility 22 is determined it qualifies that symbol as a candidate PointNode from that particular BaseNode. The time rating 42 and price rating 40 processes determine the derivative strategy acceptable path(s) as shown in FIG. 4C. Since everything has been taken into account at this stage, the symbol(s) that are best suited for the specific derivative strategy are selected for the actor and the fully composed results are presented.

As shown in FIG. 1B, the required attributes 32 include “direction”, “settlement time”, “settlement method”, “dividend”, “market destination(s)”, “shortable”, “standard contract”, “tradable”, “expiration style”, “symbol type”, “short term holding”, “index”, and so forth. “Direction” is whether the symbol or contract is long or short, meaning whether it would be purchased or sold to create a long or a short position, respectively. “Settlement time” is the method through which the final price of the underlying is determined for the purpose of valuing derivative contracts on the underlying, such as AM settlement, PM settlement or another method. “Settlement method” is the agreed upon contract terms by which the owner of a derivative contract has right(s) on an underlying. For example, settlement may happen with the delivery of a certain number of units of the underlying, cash, or physical products like barrels of oil. Other methods or combinations of methods are possible. A “dividend” is a payment made to shareholders, and can include an indication about whether the underlying is expected to provide something of value in whatever form during a derivative's contract period, the expected timing, amount of certainty, and size of the dividend. Dividends are important because they are a source of risk in a derivative strategy; and one that many actors will seek to avoid, and also a source of uncertainty that many actors will use in speculation. “Short term holding” is any position that is held for a period of time such that it is not recognized as a long-term holding by the tax code. The definition has the U.S. Tax Code in mind, but is applicable to any system where it is disadvantageous for tax purposes to sell a short-term holding. The U.S. Tax Code currently defines a short-term holding as anything owned for less than a year, and the tax rate paid by an actor with a capital gain on a short-term trade is often higher than it would be if the position were held for a long enough time to qualify it as a long-term holding. “Shortable” means whether the symbol can be sold short, where an actor sells unit(s) of the symbol that they do not own. Some symbols may not be sold short because of the nature of the symbol, sometimes there are temporary prohibitions on the short sale of a symbol (for example, an IPO period); sometimes it is difficult, prohibitively costly, or impossible to locate another actor's symbol to sell it short, or there may be another reason why the symbol is not shortable. “Symbol type” can be a financial option contract, such as a call option or put option, an underlying, such as common stock, an exchange-traded fund or a futures contract, or any other type of symbol. “Expiration style” is the rule governing when a long option can be exercised by an actor. One type of “expiration style” is European, where a contract may be exercised only at expiration, whereas an American option contract may be exercised at any point during the life of the option contract. Other types of “expiration style” exist as well, for instance Asian or Bermudian. “Tradable” means whether a symbol may be transacted in market(s). Some symbols are not tradable, such as an equity index, but may have derivative contracts trading on them. Some symbols are tradable only at certain times, such as equity options being tradable during the regular market session, but not on weekends, in extended sessions, or on market holidays. Additionally, some equity options may be traded at certain times if they are broad-based rather than narrow-based, and other distinctions may exist. Finally, some symbols are expected to be available to trade at any point of the day and at any time of year, such as contracts on foreign currency exchange rates. “Standard contract” can refer to whether or not a given derivative contract is standardized, and easily exchanged, with other contracts. It is sometimes the case that a company action with the underlying or another event will cause an adjustment in a derivative contract related to the underlying, which can change a standard contract multiplier number to a new multiple or adjust contract strike prices. It is often the case that a derivative contract that becomes non-standard can no longer be expected to be as liquid (as easily or cheaply transacted), and so may be less desirable, and some actors will eschew these derivative contracts. “Market destination(s)” can be exchanges where a symbol may be transacted and where an actor may choose to send their order. It is sometimes the case that an actor will have control and a preference over the market destination(s) to which they send an order. Certain symbols trade on certain exchanges and it may be the case that a mismatch occurs whereby an actor would seek to avoid a symbol that did not have access to market(s) that the actor felt were important or advantageous. “Index” options refers to a classification of options contracts that trade on an underlying index(es), which often have larger sized contracts and other factors. It is often the case that brokerages will have special requirements for derivatives contracts that have an “Index” as an underlying, which make it impossible or undesirable for some actors to make use of these symbols.

As used herein, option derivatives can include equity, binary, barrier, cliquet, compound, forward start, interest-rate, lookback, mountain range, rainbow, swaption, index, perpetual, reload, real, currency, employee-stock, bond, “embedded”, and so forth. Swap derivatives can include inflation, variance or volatility, interest-rate or basis, total return, credit default, equity, correlation, and so forth. Warrant derivatives can include equity, index, covered, wedding, basket, naked, detachable, and so forth. Securitized derivatives can include collateralized loan obligations (“CLOs”), collateralized fund obligation (“CFOs”), collateralized mortgage obligation (“CMOs”), mortgage-backed securities (“MBS”), credit, credit linked notes (CLN), equity-linked note (ELN), asset-backed securities, agency securities, unsecured debt, hybrid securities, and so forth. Other “lock” derivative contracts can include futures, forwards, capital guarantees, contract for difference (CFD), and so forth. Games or event derivatives can also be utilized, such as gambling, sport outcome, and so forth.

Each candidate set is assigned a rating based upon the parameters unique to the strategy. In one embodiment, complex derivative strategies are determined through composition of derivative strategies 18, where each derivative strategy has two or more “nodes”, at least one symbol in addition to BaseNode 0, and the same or fewer “locations” than symbols. These ratings are determined through the processes in FIG. 1B that pertain to price and time. In an example where symbols are selected with regard to price and time considerations, and nothing else, then—in this example—the selections would look like FIG. 4E. The difference in ideal location t₁∩p₁ and PointNode 1 at Location B contributes toward less eligibility for PointNode 1. Similarly, PointNodes 2 and 3 are compared to their ideal values at t₁∩p₂ and t₂∩p₃, respectively, where the ideal location of each PointNode at Location D is dependent upon the actual location of candidate BaseNodes 2 or 3, whichever applies.

The composition process for the specific derivative strategy is not complete at this stage, but is only complete for the factors of price rating 40 and time rating 42, which means that the symbols 70, 72A, 74A and 76B, as shown in FIG. 4D and indicated as 102 in FIG. 4C may not be the symbols ultimately selected. As is shown in FIG. 1B, the price rating takes into account both the absolute perspective on price 44 and the relative perspective on price 46, while the time rating takes into account both the absolute perspective on time 48 and the relative perspective on time 50. Some nodes and some perspectives are more important to final composition than others, which may influence the determination of candidate PointNodes.

The composition process for the specific derivative strategy may take into account the strategy net premium rating 34, where candidate PointNode eligibility 22 is influenced by the additive net premium of the symbols that comprise the specific derivative strategy. A specific net premium may be indicated for the derivative strategy, such as a value of zero, where deviations from this value contribute toward a lower strategy net premium rating 34.

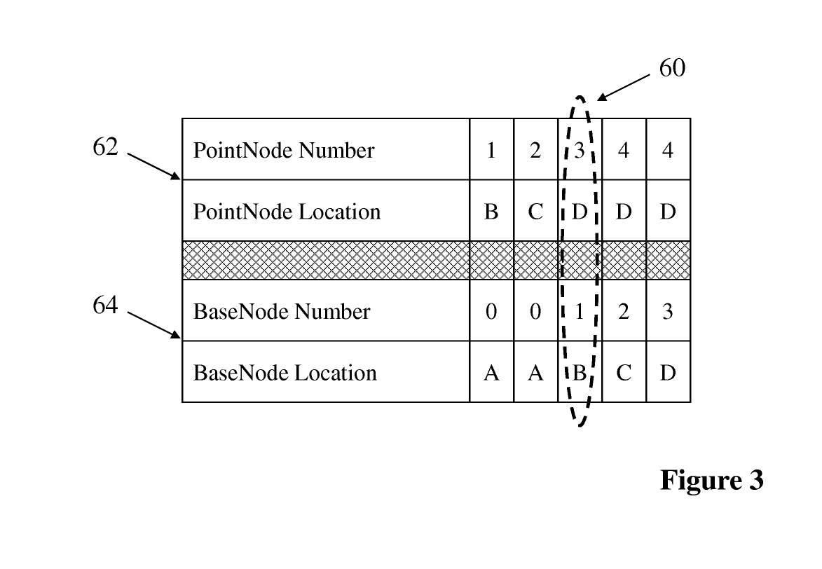

As an example for use in a particular embodiment of the present invention, FIG. 2 depicts Black-Scholes gamma, as derived from the Black-Scholes option pricing model (Black, Fischer; Myron Scholes (1973)). “The Pricing of Options and Corporate Liabilities.” Journal of Political Economy 81 (3): 637-654.) There are other option pricing formulas, such as Leisen-Reimer, Bjerksund-Stensland, Cox-Ross-Rubinstein Binomial, and many others. As one of skill in the art would readily know and understand, Black-Scholes gamma is one of many strategy analytics, there are many others, including Black-Scholes delta, Cox-Ross-Rubinstein theta, Leisen-Reimer Vanna, and so on. Gamma is the second derivative of the option pricing formula with respect to the price of the underlying, and it is used to estimate the convexity for the strategy, which is a mathematical concept. Gamma is estimated slightly differently depending upon the formula, but each estimation will take into account or make assumptions about one or more variables or inputs, such as, time until expiration, contract strike price, value of the underlying, implied volatility, and interest-rate. These strategy analytics, like gamma, may be used by the actor to determine which specific derivative strategy is best suited for their intent, since each specific derivative strategy will have different values for each strategy analytic, and each derivative strategy will share certain strategy analytic commonalities. These determinations by the actor, when they happen, occur after the processes of the apparatus and method have concluded. Instructions like those in FIG. 3 and parameters for the determination of candidate PointNode eligibility 20 may use all of the inputs of FIG. 1B. Regardless of the type of derivative strategy, the number of factors, or the specific instructions or parameters, candidate PointNode eligibility 20 must be determined from BaseNodes, a best version of the derivative strategy must be determined through composition of derivative strategies 18 and specific derivative strategies must be eliminated that are not fully appropriate to the actor's forecast for the underlying (user's market sentiment) 14. By way of example, FIGS. 3-4E show a general embodiment of the present invention. FIG. 3 shows a hypothetical example summary of the PointNodes 62 and BaseNodes 64 at Locations A-D. A given column describes the relation between a BaseNode and PointNode and the locations of the nodes, where for instance one such relation 60 is indicated in FIG. 3. Evaluative ratings are generated for some or all attribute(s) of a symbol. For example, when the factors related to liquidity rating 24 are being evaluated, the bid-ask spread perspective 26, volume perspective 28 and open interest perspective 30 may be taken into account, as they all serve as proxies for the liquidity environment that can be expected if/when the actor interacts in a market to establish a position, close a position, or both, either at one or more than one point in time. As one of skill in the art would readily appreciate, a lower bid-ask spread is favorable, as is a higher volume and open interest, although these concerns are not of equal importance and are not consistently important across derivative strategies. In certain embodiments, these ratings are combined according to the specified importance of each, aggregated into liquidity rating 24 for the symbol, contributing toward the rating for the derivative strategy. In the present example, price rating 40, time rating 42, strategy net premium rating 34, liquidity rating 24 and required attributes 32 contribute toward the determination of candidate PointNode eligibility 22 for each candidate PointNode.

FIGS. 4A-4E show nodes A, B, C and D in a two dimensional chart. The notation of the axis refers to time and price, where t₀ refers to now, t₁ refers to some future date, and t₂ refers to a future date occurring after t₁, p₁ refers to the ideal price at Location B, p₂ at Location C and p₃ at Location D, although the axis units could be any other type of units and the number of axis need not by limited to two or be more numerous than one.

Selection of candidate PointNodes is dependent upon the parameter values unique to the strategy definition, some of which are shown for a particular example in FIG. 3. From the price and time perspective they are selected according to the absolute perspective on price 44, relative perspective on price 46, absolute perspective on time 48 and relative perspective on time 50, by way of example, as shown in FIG. 1B. More than one symbol may exist at a Node location. The absolute perspective is the cardinal difference from the BaseNode. For example, absolute perspective parameters specifying plus $3 and plus 47 days, with a BaseNode at 30 days∩$40, would give a target for PointNode candidates at 77 days∩$43.

FIG. 4A shows the ideal location B 72 at t₁∩p₁ and the ideal location C 74 at t₁∩p₂, the ideal location D 76 is at t₂∩p₃, while Node A 70 is the market data and so is only a BaseNode, not a PointNode and does not go through the selection process. FIG. 4A shows the ideal location B 72 at t₁∩p₁ and the ideal location C 74 at t₁∩p₂, both of which are dependent upon Location A, absolute perspective on price 44, relative perspective on price 46, absolute perspective on time 48 and relative perspective on time 50.

FIG. 4A shows the ideal Location D 76 at t₂∩p₃, which is dependent upon the candidate PointNode locations that exist for Location B 72 and Location C 74, respectively. Since there are two symbols for Location D 76, one from Location B 72 and the other from Location C 74, the candidate PointNodes for Location D 76 may exist at the same location or at more than one location. Candidate PointNodes for Location D 76 partially depend upon BaseNode B 72 and BaseNode C 74.

FIG. 4B shows another example of an alternative embodiment of the present invention. The reason that the target locations are not simply selected for at the ideal locations 70, 72, 74, 76, as in FIG. 4A, is that symbols do not exist at every strike price and every expiration date. The locations of candidate PointNodes are determined through the processes 44, 46, 48, 50 in FIG. 1B. For example, relative perspective on price 46 pertains to the percentage increase or decrease in relation to a reference length on the price axis. To determine a price target when the BaseNode 70 is market data would use the market price less the minimum price (which is zero) as a base length, and determine a target point as a percentage change. In this example, if the BaseNode A 70 were at $10, and the relevant price is $9.80, where [($10−$9.80)($10.00)=−2%], this information would contribute toward the selection of symbols for the one or more PointNodes, such as those at location B 72A, 72B in FIG. 4B.

FIG. 4D shows the process of determining PointNodes from BaseNodes for an exemplary embodiment. The Net-Long-Strangle-Straddle-Swap Strategy is type of Double-Diagonal Strategy, where, for example, another type of Double-Diagonal Strategy is the Net-Short-Straddle-Strangle-Swap Strategy. The Net-Long-Strangle-Straddle-Swap Strategy is constituted by a Short-Strangle Strategy in a near contract expiration time 72, 74 in FIG. 4A and a Long-Straddle Strategy at a far contract expiration time 76 in FIG. 4A. The Short-Strangle Strategy is comprised of a Short-Call Strategy at a near contract expiration time 74 and a Short-Put Strategy at the same contract expiration time 72. The Long-Straddle Strategy is comprised of a Long-Call Strategy at a far contract expiration time 76 and a Long-Put Strategy at the same contract expiration time 76. The near contract expiration time, t₁ in FIG. 4A, must be at a time future to the present, t₀ in FIG. 4A; and the far contract expiration time, t₂ in FIG. 4A, must be at a time future to the near contract expiration time. For the exemplary embodiment, the absolute values of the quantities of contracts must be identical for each constituent instrument 72, 74, 76 in FIG. 4A. The contract strike prices of the instruments at the far contract expiration time 76 must be identical in number to create the Long-Straddle Strategy; contract strike price 76 should be near the average of the contract strike prices of the instruments at the near expiration time 72, 74 in FIG. 4A. An example of Net-Long-Strangle-Straddle-Swap Strategy is, assuming today is January 1^{st} and these dates are all of the same year: short 5 February 20 strike calls, short 5 February 10 strike puts, long 5 June 15 strike calls and long 5 June 15 strike puts.

The number of PointNodes for each BaseNode is set to two for ease of explanation, while there can be any number of PointNodes, and the indicated nodes 70 72A 74A 76B correspond to the description in FIG. 3, where those specific nodes correspond to available symbols and are used to construct the hypothetical example. FIG. 4D shows PointNodes 72A and 72B at location B being determined from BaseNode 70 at location A. PointNodes 74A and 74B are determined from BaseNode 70. PointNodes 76A and 76B are determined from BaseNode 72A. Additional PointNodes for 76A and 76B are determined from BaseNode 72B. Some nodes are BaseNodes, but are not PointNodes, such as 70. Some PointNodes have more than one BaseNode, such as 76B. Some BaseNodes may have fewer or no PointNodes. Some BaseNodes to PointNode relations share a location, such as 76E, where the BaseNodes are at 74B and 76B. The particulars of the process differ for various derivative strategies, where each unique process corresponds to a unique derivative strategy. This process continues in a similar fashion until all of the relevant PointNodes are determined from the appropriate BaseNodes.

A further example of the candidate paths is shown in FIG. 4C. It may be noted that with two PointNodes per BaseNode there may exist more than the nine PointNode locations shown in FIG. 4B, but that the number of locations shown is less because some PointNode locations share a BaseNode. Progressing from BaseNode 0 at Location A 70 according to the instructions in FIG. 3, generates 128 paths (in this example), with 64 candidate sets of symbols for PointNodes 1-4, as shown in FIG. 4C. One of these candidate sets of symbols will be determined to be the best, having the highest rating, when all relevant factors are considered.

Each candidate set in FIG. 4C is assigned a rating based upon the parameters unique to the strategy. Some of these rating are determined through the processes in FIG. 1B that pertain to price and time. If symbols were selected with regard to price and time considerations, and nothing else, then (in this hypothetical example) the selections would look like FIG. 4E. The difference in ideal location t₁∩p₁ and PointNode 1 at Location Bcontributes toward less eligibility for PointNode 1 72A. Similarly, PointNode 2 is compared to its ideal value at t₁∩p₂, PointNodes 3 and 4 at t₂∩p₃, where the ideal location of each PointNode at Location D 76, as shown in FIG. 4A, is dependent upon the actual location of candidate BaseNodes 1 or 2, as shown in FIG. 4E, whichever applies.

As was explained above in reference to FIG. 1B, the composition process for the strategy is not complete at this stage, but is only complete for the perspectives of price and time, which means that the candidate path 102, as shown in FIG. 4C, and FIG. 4E 70 72A 74A 76B may not be the symbols ultimately selected. Some nodes and some BaseNode to PointNode relations are more important to composition than others, which may influence the determination of PointNodes.

Then, symbols are definitively selected from the candidate paths FIG. 4C; this provides the best composition for the given strategy as shown in FIG. 4D. This composition has a rating assigned to it to describe the extent to which it conforms to the ideal as shown in FIG. 4A. In some embodiments that rating is shared with the actor to convey information about the degree to which the strategy presented conformed to the ideal of that strategy, as contrasted with FIG. 4A and FIG. 4E.

FIG. 5 shows the Strategy Risk/Reward Profile (payoff diagram) of the exemplary derivative strategy Net-Long-Strangle-Straddle-Swap where all contracts have time until expiration. The expected payoff, which is a gain/loss pre-transactions costs and taxes, is on the vertical axis, with the first curve 82 for a given value of the underlying as plotted against strike prices on the horizontal axis, for the present time; the second curve 84 plots an estimate of the payoff as it is expected on the date that the short option contracts, in the exemplary embodiment 72A and 74A in FIG. 4E, expire. The first curve 82 will converge to the shape of the second curve 84 over the remaining life of the option contracts at an increasing pace. Line m plots the maximum loss possible from the specific derivative strategy; line p plots the maximum gain. The maximum gain is found at a value for the underlying upon expiration of the short option contracts at the prices plotted by line g or i; f f∩n and j∩n show where the payoff would be zero upon expiration of the short contracts (excluding transactions costs and other details). The curve representing the present time 82 plots an estimate of the maximum payoff for the specific derivative strategy at h∩o for possible changes in the value of the underlying. Lines e and k plot the lower and upper bound where a lower or higher underlying price is estimated to make no material difference to the value of the specific derivative strategy, since it is already at the maximum loss m.

Although the present invention has been described with reference to preferred embodiments, persons skilled in the art will recognize that changes may be made in form and detail without departing from the spirit and scope of the invention.

I claim:

1. A method for determining derivative strategies and composition thereof, comprising:
a. providing a computer connected to a database having access to market data;
b. establishing an actor's market sentiment as to at least one underlying;
c. identifying at least one candidate derivative strategy based upon the actor's market sentiment for the underlying by evaluating symbols, said identification further comprising:
i. establishing at least one candidate symbol from the underlying;
ii. establishing at least one base node from the market data;
iii. establishing at least one point node from each base node based on the user's market sentiment;
iv. discarding or selecting the candidate symbol based on the resulting BaseNode to PointNode calculations resulting from the actor's market sentiment; and
d. displaying the identified symbol and derivative strategy to an actor on said computer.

2. The method of claim 1, wherein the actor's market sentiment further comprises market data, context, and transaction costs.

3. The method of claim 1, wherein the actor's market sentiment further comprises implied volatility.

4. The method of claim 1, wherein the candidate derivative strategy is selected from the group consisting of: option derivatives, swap derivatives, warrant derivatives, securitized derivatives, other “lock” derivative contracts, game or event derivatives, and Asian, barrier, binary, cliquet, compound option, forward start option, interest rate option, lookback, mountain range, rainbow option, swaption, back spread with calls, back spread with puts, cash-secured put, christmas tree butterfly with calls, christmas tree butterfly with puts, collar, covered call, diagonal spread with calls, diagonal spread with puts, double diagonal, fig leaf, front spread with calls, front spread with puts, inverse skip strike butterfly with calls, inverse skip strike butterfly with puts, iron butterfly, iron condor, long butterfly spread with calls, long butterfly spread with puts, long calendar spread with calls, long calendar spread with puts, long call, long call spread, long combination, long condor spread with calls, long condor spread with puts, long put, long put spread, long straddle, long strangle, protective put, short call, short call spread, short combination, short put, short put spread, short straddle, short strangle, skip strike butterfly with calls, skip strike butterfly with puts, covered calls, buy-writes, covered call roll-ups, roll-downs, synthetic long puts, married puts, long calls, long puts, long straddles, long strangles, covered puts, equity debit spreads, equity credit spreads, equity calendar/diagonal spreads, index debit spreads, index credit spreads, index calendar, diagonal spreads, naked equity puts, butterflies, iron butterflies, condors, iron condors, naked equity calls, naked index calls, naked index puts, covered calls, covered puts, buy-writes, unwinds, covered rollouts, protective puts, long calls, long puts, long straddles, long combinations, long strangles cash-secured equity puts, speculation income, spreads diagonal, call spreads, diagonal put, spreads ratio spreads, long side heavy, speculation income, uncovered calls, uncovered puts, uncovered rollouts, short straddles, short combinations, short strangles, uncovered ratio spreads, covered call writing of equity options, purchases of calls and puts, writing of cash covered puts, purchases of straddles, combinations, collars, conversions of equities, hedged puts and calls, equity and index spreads, covered put writing, reverse conversions of equity options, uncovered writing of equity options, uncovered writing of straddles or combinations on equities, convertible hedging, uncovered writing of index options, uncovered writing of straddles or combinations on indexes, covered index options, collars and conversions of index options, equity, call, put, call vertical, put vertical, call back/ratio, put back/ratio, call calendar, put calendar, call diagonal, put diagonal, straddle, strangle, covered stock, collar/synthetic combination, call butterfly, put butterfly, call condor, put condor, iron condor, call vertical roll, put vertical roll, collar with stock, unbalanced call butterfly, unbalanced put butterfly, unbalanced call condor, unbalanced put condor, unbalanced iron condor, unbalanced call vertical roll, unbalanced put vertical roll, double call diagonal, double put diagonal, double call calendar, double put calendar, straddle strangle swap, and strangle straddle swap.

5. The method of claim 1, wherein the underlying asset is selected from the group consisting of: property, freight, inflation, interest-rates, basis, weather, exchange rates, equity, credit, volatility and variance, assets, games, notes, bonds, durations, natural resource deposits, commodities, real options, account balances, credit defaults, political events, economic events, derivatives, exchanges traded, over-the-counter derivative contracts, speculative assets, hedges, standard options, barrier options, coupe options, mountain options, knock-ins, swaps, swaptions, warrants, range accruals, caps and floors, forward-rate agreements, vanilla options, American style options, European style options, exotic options, Asian style options and Bermudan style options.

6. A method for selecting derivative strategies and composition thereof, comprising:
a. providing a computer connected to a database having access to market data;
b. establishing an actor's market sentiment as to at least one underlying;
c. identifying a subset of appropriate derivative strategies by compiling characteristic information about each said underlying from said network, further comprising:
i. selecting an appropriate subset of the derivative strategies by evaluating said characteristic information;
ii. establishing at least one base node for an underlying based upon the characteristic information of the underlying;
iii. establishing at least one point node for each underlying according to the actor's forecast for the underlying;
iv. selecting derivative strategies and point nodes appropriate for the forecast for the underlying; and
d. displaying the selected subset of derivative strategies by way of said computer.

7. The method of claim 6, wherein the actor's market sentiment further comprises market data, context, and transaction costs.

8. The method of claim 6, wherein the actor's market sentiment further comprises implied volatility.

9. The method of claim 6, wherein the candidate derivative strategy is selected from the group consisting of: barrier, binary, cliquet, compound option, forward start option, interest rate option, lookback, mountain range, rainbow option, swaption, back spread with calls, back spread with puts, cash-secured put, christmas tree butterfly with calls, christmas tree butterfly with puts, collar, covered call, diagonal spread with calls, diagonal spread with puts, double diagonal, fig leaf, front spread with calls, front spread with puts, inverse skip strike butterfly with calls, inverse skip strike butterfly with puts, iron butterfly, iron condor, long butterfly spread with calls, long butterfly spread with puts, long calendar spread with calls, long calendar spread with puts, long call, long call spread, long combination, long condor spread with calls, long condor spread with puts, long put, long put spread, long straddle, long strangle, protective put, short call, short call spread, short combination, short put, short put spread, short straddle, short strangle, skip strike butterfly with calls, skip strike butterfly with puts, covered calls, buy-writes, covered call roll-ups, roll-downs, synthetic long puts, married puts, long calls, long puts, long straddles, long strangles, covered puts, equity debit spreads, equity credit spreads, equity calendar/diagonal spreads, index debit spreads, index credit spreads, index calendar, diagonal spreads, naked equity puts, butterflies, iron butterflies, condors, iron condors, naked equity calls, naked index calls, naked index puts, covered calls, covered puts, buy-writes, unwinds, covered rollouts, protective puts, long calls, long puts, long straddles, long combinations, long strangles cash-secured equity puts, speculation income, spreads diagonal, call spreads, diagonal put, spreads ratio spreads, long side heavy, speculation income, uncovered calls, uncovered puts, uncovered rollouts, short straddles, short combinations, short strangles, uncovered ratio spreads, covered call writing of equity options, purchases of calls and puts, writing of cash covered puts, purchases of straddles, combinations, collars, conversions of equities, hedged puts and calls, equity and index spreads, covered put writing, reverse conversions of equity options, uncovered writing of equity options, uncovered writing of straddles or combinations on equities, convertible hedging, uncovered writing of index options, uncovered writing of straddles or combinations on indexes, covered index options, collars and conversions of index options, equity, call, put, call vertical, put vertical, call back/ratio, put back/ratio, call calendar, put calendar, call diagonal, put diagonal, straddle, strangle, covered stock, collar/synthetic combination, call butterfly, put butterfly, call condor, put condor, iron condor, call vertical roll, put vertical roll, collar with stock, unbalanced call butterfly, unbalanced put butterfly, unbalanced call condor, unbalanced put condor, unbalanced iron condor, unbalanced call vertical roll, unbalanced put vertical roll, double call diagonal, double put diagonal, double call calendar, double put calendar, straddle strangle swap, and strangle straddle swap.

10. The method of claim 6, wherein the underlying asset is selected from the group consisting of: property, freight, inflation, interest-rates, basis, weather, exchange rates, equity, credit, volatility and variance, assets, games, notes, bonds, durations, natural resource deposits, commodities, real options, account balances, credit defaults, political events, economic events, derivatives, exchanges traded, over-the-counter derivative contracts, speculative assets, hedges, standard options, barrier options, coupe options, mountain options, knock-ins, swaps, swaptions, warrants, range accruals, caps and floors, forward-rate agreements, and so forth, vanilla options, American style options, European style options, exotic options, Asian style options and Bermudan style options.

11. A method for selecting derivative strategies and composition thereof, comprising:
a. providing a computer connected to a network;
b. establishing an actor's market sentiment as to at least one underlying;
c. evaluating derivative strategies by eliminating derivative strategies for the underlying(s) inconsistent with the actor's market sentiment when considered comprehensively, further comprising:
i. selecting at least one underlying;
ii. establishing at least one base node and at least one point node for each the underlying for derivative strategies based on the actor's market sentiment;
iii. discarding derivative strategies for underlying(s) inconsistent with the actor's market sentiment when combined with externalities; and
d. displaying the resulting derivative strategies which have not been discarded, by way of the computer.

12. The method of claim 11, wherein the externalities further comprises market data, context, and transaction costs.

13. The method of claim 11, wherein the actor's market sentiment further comprises implied volatility.

14. The method of claim 11, wherein the candidate derivative strategy is selected from the group consisting of: barrier, binary, cliquet, compound option, forward start option, interest rate option, lookback, mountain range, rainbow option, swaption, back spread with calls, back spread with puts, cash-secured put, christmas tree butterfly with calls, christmas tree butterfly with puts, collar, covered call, diagonal spread with calls, diagonal spread with puts, double diagonal, fig leaf, front spread with calls, front spread with puts, inverse skip strike butterfly with calls, inverse skip strike butterfly with puts, iron butterfly, iron condor, long butterfly spread with calls, long butterfly spread with puts, long calendar spread with calls, long calendar spread with puts, long call, long call spread, long combination, long condor spread with calls, long condor spread with puts, long put, long put spread, long straddle, long strangle, protective put, short call, short call spread, short combination, short put, short put spread, short straddle, short strangle, skip strike butterfly with calls, skip strike butterfly with puts, covered calls, buy-writes, covered call roll-ups, roll-downs, synthetic long puts, married puts, long calls, long puts, long straddles, long strangles, covered puts, equity debit spreads, equity credit spreads, equity calendar/diagonal spreads, index debit spreads, index credit spreads, index calendar, diagonal spreads, naked equity puts, butterflies, iron butterflies, condors, iron condors, naked equity calls, naked index calls, naked index puts, covered calls, covered puts, buy-writes, unwinds, covered rollouts, protective puts, long calls, long puts, long straddles, long combinations, long strangles cash-secured equity puts, speculation income, spreads diagonal, call spreads, diagonal put, spreads ratio spreads, long side heavy, speculation income, uncovered calls, uncovered puts, uncovered rollouts, short straddles, short combinations, short strangles, uncovered ratio spreads, covered call writing of equity options, purchases of calls and puts, writing of cash covered puts, purchases of straddles, combinations, collars, conversions of equities, hedged puts and calls, equity and index spreads, covered put writing, reverse conversions of equity options, uncovered writing of equity options, uncovered writing of straddles or combinations on equities, convertible hedging, uncovered writing of index options, uncovered writing of straddles or combinations on indexes, covered index options, collars and conversions of index options, equity, call, put, call vertical, put vertical, call back/ratio, put back/ratio, call calendar, put calendar, call diagonal, put diagonal, straddle, strangle, covered stock, collar/synthetic combination, call butterfly, put butterfly, call condor, put condor, iron condor, call vertical roll, put vertical roll, collar with stock, unbalanced call butterfly, unbalanced put butterfly, unbalanced call condor, unbalanced put condor, unbalanced iron condor, unbalanced call vertical roll, unbalanced put vertical roll, double call diagonal, double put diagonal, double call calendar, double put calendar, straddle strangle swap, and strangle straddle swap.

15. The method of claim 11, wherein the underlying asset is selected from the group consisting of: property, freight, inflation, interest-rates, basis, weather, exchange rates, equity, credit, volatility and variance, assets, games, notes, bonds, durations, natural resource deposits, commodities, real options, account balances, credit defaults, political events, economic events, derivatives, exchanges traded, over-the-counter derivative contracts, speculative assets, hedges, standard options, barrier options, coupe options, mountain options, knock-ins, swaps, swaptions, warrants, range accruals, caps and floors, forward-rate agreements, and so forth, vanilla options, American style options, European style options, exotic options, Asian style options and Bermudan style options.
